(19) United States
(12) Patent Application Publication
(10) Pub. No.: US 2018/0130067 A1
(43) Pub. Date: May 10, 2018

(54) MANAGING AGENT RELATIONSHIPS WITH A SET OF CONTACTS VIA TEMPLATED MESSAGES

(71) Applicant: ROBERT T. LINDSAY, SAN FRANCISCO, CA (US)

(72) Inventor: ROBERT T. LINDSAY, SAN FRANCISCO, CA (US)

(21) Appl. No.: 15/671,934

(22) Filed: Aug. 8, 2017

Related U.S. Application Data
(60) Provisional application No. 62/481,812, filed on Apr. 5, 2017.
(60) Provisional application No. 62/373,347, filed on Aug. 10, 2016.
(60) Provisional application No. 62/542,592, filed on Aug. 8, 2017.

(51) Int. Cl. G06Q 30/00; G06Q 10/06; H04W 4/12

(52) U.S. Cl. CPC G06Q 30/01; G06Q 10/109; H04W 4/12; G06Q 10/06311

(57) ABSTRACT

A computerized method useful for managing agent relationships with a set of contacts via templated messages includes the step of providing a goal of an entity organization. The computerized method includes the step of providing a set of leads; identifying an agent, wherein the agent has a pre-existing relationship with the set of leads. The computerized method includes the step of assigning the agent to the set of leads. The computerized method includes the step of generating a templated message. The templated message is addressed to the set of leads and include a set of templated text related to the goal of the entity organization. The computerized method includes the step of communicating the templated message to the agent. The agent is enabled to modify the templated message, and wherein the agent implements with each individual lead of the set of leads.

### CLAIM OF PRIORITY AND INCORPORATION BY REFERENCE

This application claims priority to U.S. Provisional Application No. 62/481,812, titled and MANAGING AGENT RELATIONSHIPS WITH A SET OF CONTACTS VIA CURATED TEXT MESSAGES filed on 5 Apr. 2017. This provisional application is incorporated by reference in its entirety.

This application claims priority to U.S. Provisional Application No. 62/373,347, titled and MANAGING ENGAGEMENT WITH A SET OF CONTACTS VIA CURATED TEXT MESSAGES FROM ASSIGNED AGENTS filed on 10-Aug.-2016. This provisional application is incorporated by reference in its entirety.

This application claims priority to U.S. Provisional Application No. 62/542,592, titled and MANAGING AGENT RELATIONSHIPS WITH A SET OF CONTACTS VIA TEMPLATED MESSAGES filed on 8-Aug.-2017. This provisional application is incorporated by reference in its entirety.

### BACKGROUND

### Field of the Invention

This application relates generally to text messaging, and more specifically to a system, article of manufacture and method of managing agent relationships with a set of contacts via templated messages.

### Description of the Related Art

Organizations can leverage text messaging to manage and coordinated various campaigns such as fund raisers, political campaigns, volunteer activates, etc. Spamming and/or otherwise mass texting participants can have negative results and/or decreasing participant activity. At the same, organizations can include members with a historical or other type of relationship with the participants. Accordingly, improvements to text-messaging technology are desired to, in turn, enable organizations to manage various members with pre-existing relationships with a set of contacts.

### BRIEF SUMMARY OF THE INVENTION

In one aspect, a computerized method useful for managing agent relationships with a set of contacts via templated messages includes the step of providing a goal of an entity organization. The computerized method includes the step of providing a set of leads; identifying an agent, wherein the agent has a pre-existing relationship with the set of leads. The computerized method includes the step of assigning the agent to the set of leads. The computerized method includes the step of generating a templated message, wherein the templated message is addressed to the set of leads and comprises a set of templated text related to the goal of the entity organization, and wherein the set of templated text is written by an administrator of the entity organization. The computerized method includes the step of communicating the templated message to the agent, wherein the agent is enabled to modify the templated message, and wherein the agent implements with each individual lead of the set of leads. The computerized method identifies a set of relationships between the agent and the individual lead. Based on the set of relationships, the computerized method includes the step of modifies the templated message. The computerized method communicates, from a templated-text message application implemented in a computing device of the agent, via an electronic text-messaging network an individualized templated message to another computing device of the individual lead.

### BRIEF DESCRIPTION OF THE DRAWINGS

FIG. 1 illustrates an example system for managing engagement with a set of contacts via templated messages from assigned agents, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example process for managing engagement with a set of contacts via templated messages from assigned agents, according to some embodiments.

FIG. 5 illustrates an example process for managing agent interactions with a set of leads, according to some embodiments.

FIG. 6 illustrates an example process of selecting agents to be matched with a set of leads, according to some embodiments.

FIG. 7 illustrates another example process of selecting agents to be matched with a set of leads, according to some embodiments.

FIG. 8 illustrates an example process for updating which agents are assigned to a subset of clients.

FIG. 9 illustrates an example process for tracking lead engagement, according to some embodiments.

The Figures described above are a representative set, and are not an exhaustive with respect to embodying the invention.

### DESCRIPTION

Disclosed are a system, method, and article of manufacture for managing agent relationships with a set of contacts (e.g. leads) via templated messages. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other Instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Customer relationship management (CRM) can be an approach to managing a company's interaction with current and potential future customers. The CRM approach can analyze data about customers' history with a company, to improve business relationships with customers, for example, focusing on customer retention.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Text messages can be electronic messages between two or more mobile phones and/or other computing devices. Text messages can include, Inter alia, Short Message Service (SMS) messages, multimedia messages (known as MMS) messages, instant messaging system messages, e-mails, and the like.

### EXAMPLE EMBODIMENT

An entity (e.g. an election campaign, an alumni organization, a business, a non-profit organization, a fundraising campaign, an educational organization, etc.) can assign leads to agents. A lead can be a volunteer, alumni group member, employee, etc. An entity can utilize communicate text messages to a set of leads via an agent. An agent can be a volunteer, supervisor, local organizer, etc. The text messaging application can include a to-do list for an agent. An administrator for the entity can creates template-text messages. The agents can edit, customize and/or personalize template-text messages and communicate them (e.g. via a messaging service) to specified leads. For example, an agent can analyze the agent's relationship with each individual lead, use this relationship information to fill in a template in the message, and then communicate these individualized messages one-to-one to a set of specified leads.

Based on the goals of the entity, an administrator can generate structured texting workflows. These texting workflows can be put into a template format. For example, the entity is organizing an event (e.g. a rally for a candidate). The messaging template can provide a time, date, place and/or other general information. The entity can then break goal type into one or multiple (e.g. two (2), etc.) steps. A first step can be an invitation to be communicated to the relevant leads. For example, an invitation templated message can be sent to the leads via the agent a week before the event. A templated message can be a script that includes targeting criterion determined by the entity. An agent can use this script as a basis and then incorporate additional specific and/or personalized information about a lead into script as well. An agent can also access other scripts to integrate. For example, sample introduction scripts can be provided.

Template reminder messages can also be provided. For example, if a lead says ‘yes’ to an invitation to attend an event, then a reminder message can also automatically be sent to the agent to send to the lead (e.g. a day or two days before event). Scripts can include informal and personal language that ends with a question for engagement, etc.

An agent can have an application (e.g. a mobile-device text messaging application) that includes various windows and/or other GUI elements that enable the agent to modify and/or communicate templated text messages (e.g. based on a set of parameters determined by the entity acting as a central authority.

The entity can also monitor which agents have performed various actions. For example, an entity can see what leads have received various text messages from specified agents. The entity can assign new agents specified sets of leads. These leads can also be reassigned to other agents. New agents can automatically see the conversation text thread between the leads and prior agents. The entity can push messages to agents to ‘nudge’ them to perform certain actions (e.g. send a reminder to a list of leads, etc.). The application can automatically queue a plurality of text-message threads. An agent can then take action on each message to customize it prior to sending it to a lead.

From a lead's perspective, the text-messages arrive as a text directly from an agent (e.g. someone the lead knows personally, is familiar with or has some known connection with, is with an organization or campaign that the lead supports, a business the lead is customer of, etc.). In some example embodiments, an agent can manage a lead's RSVP state based on the leads responses. The agent can toggle the message template, the leads only receive a one-to-one text message from a human. The agent can immediately be provided response scripts to reply to the lead (e.g. ‘great see you there’) plus simple CRM features (e.g. occupation, employer, tags, etc.). All communications between a lead and an agent can be visible to an entity's administrator (e.g. via a dashboard interface that provides analytics and other information about the state all the conversational text-message threads active in the system, etc.). In this way, an entity can filter its communications with leads through a personalized conversation sent out by team of agents with existing communication threads with said leads. Agents can put the entity's goals and message into own voice and receive structured responses from the leads. The data from these structured responses can then be easily stored and analyzed.

In another example, a set of leads can be determined. For example, a campaign/event to contact leads can be initiated. Example campaigns include, inter alia: fund raisers, political events, party or other social gathering, educational events, sports events, etc. The set of leads can be divided into subsets of leads. For example, each agent involved with the campaign can be assigned an equal portion of the set of leads. In other examples, for various reasons, the agents can be assigned unequal portions of the set of leads. The agent can be provided a set of activities to accomplish with each lead in the agent's subset of leads. A time limit and/or other metrics can be assigned to the agent's interactions with each lead. In the example of a fundraiser, each agent can be given a time limited to contact each assigned lead and request a charitable gift. Each agent can be assigned a script and/or other materials to provide to the lead. The agent's interactions can be monitored, stored and algorithmically reviewed. In the event an agent does not fulfill an obligation within a specified time period, other agents can be reassigned some or all of the agent's leads. The assignment can be temporary with the reassigned leads reverting to the original agent. For example, an agent can be unavailable for a period and the agent's leads can be automatically reassigned. When the agent returns to the availability in the campaign then the reassigned leads can be given back to the agent. A portion of the agent's leads can also be reassigned if it is detected that the agent is not making progress at a specified rate. For example, if the agent has fallen behind the other lead contact statistics of other agents, then a portion of the agent's leads can be provided to the other agents until the agent has caught up to the agent lead-contact average or other statistic. Other examples are provided infro.

Example Computer Architecture and Systems

In one example, a system is provided whereby an organization can leverage agents to send messages on the organization's behalf. The organization (e.g. one or more administrators within the organization) can generate message templates and queues said templates in an agent's messaging application. Message templates can be intelligently provided based on various conversational contexts. For example, if the message is a first message to a lead/contact, the message can include an introduction. If a messaging thread between the agent and lead/contact has already be generated, then the introduction can be removed and various follow-up content (e.g. reminders, etc.) can be included. The agents can be take various actions with a message template. For example, an agent can customize a message that includes all or a portion of the message template. From the perspective of a lead, the information and/or invitations from the organization arrive as messages from an agent that the lead may be familiar with on a personal level. The agent's messaging application can send a push notification when a lead responds. The agent can then toggle a new screen in the messaging application interface where can he can change an RSVP state of the lead (e.g. by pressing a virtual button, etc.). The messaging application can then provide response scripts to reply to the lead (e.g. ‘great see you there’) plus various CRM features (e.g. occupation, employer, tags, etc.). An administrator can view/manages this activity. The administrator can take various actions such as nudge agents, review response statistics, etc.

In this way, the organizational goals can be filtered through natural messaging conversations sent out by a team of agents with existing thread. Agents can put these organizational goals into their own voice, as well as, receive structured responses. The data from these structured message threads between agents and leads can then be stored and analyzed.

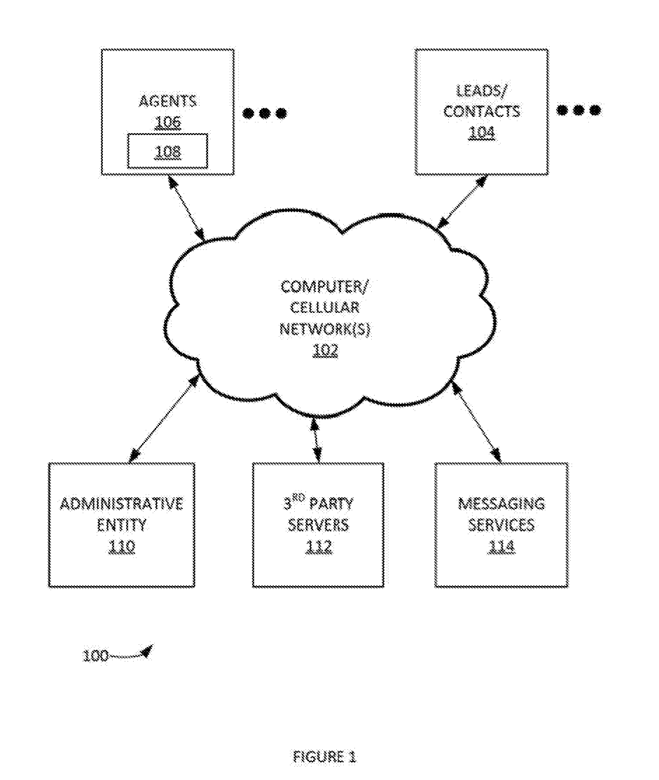

FIG. 1 illustrates an example system 100 for managing engagement with a set of contacts via templated messages from assigned agents, according to some embodiments. System 100 can include various computer and/or cellular data networks 100. Networks 100 can include the Internet, text messaging networks (e.g. short messaging service (SMS) networks, multimedia messaging service (MMS) networks, proprietary messaging networks, instant messaging service networks, email systems, etc. Networks 100 can be used to communicate messages and/or other information from the various entities of system 100.

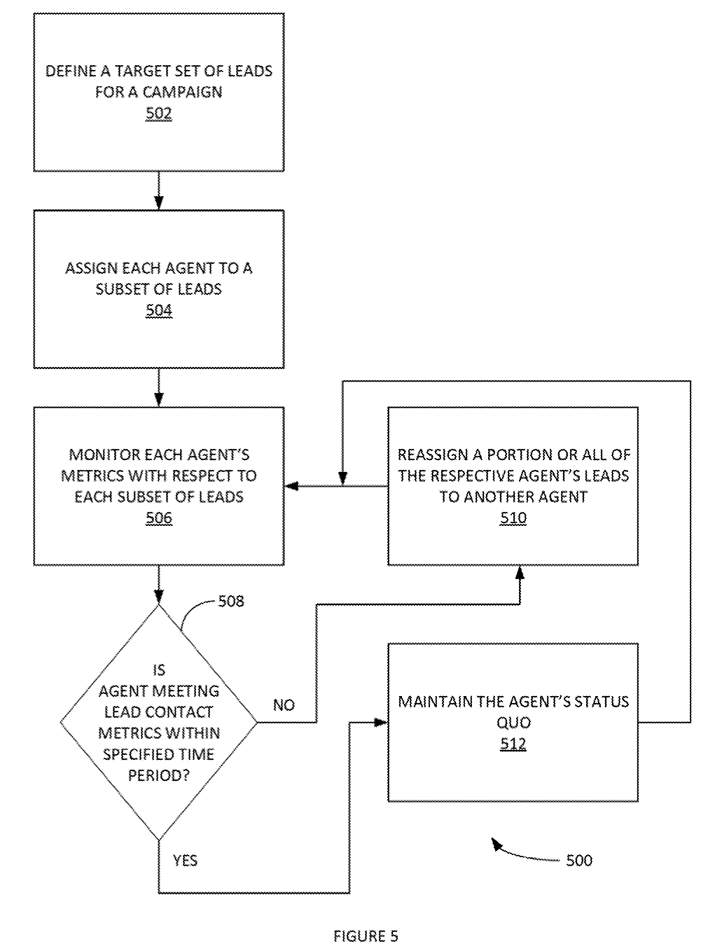

System 100 can include agent computing devices 106 (hereafter ‘agents’). In some examples, the agent computing device can be a mobile device. Agents 102 can operate a mobile device that includes a messaging application 108. Agents 102 can operate messaging application 108. Messaging application 108 can enable agents 102 to send text messages, documents, photos, videos, contact information, and/or group messages over Wi-Fi, mobile phone Internet access, other forms of Internet access standard SMS/MMS messaging networks, etc. Messaging application 108 can be utilized to organize/curate messages to specified sets of lead computing devices 104 (hereafter ‘leads’). Messaging application 108 can provided an application interface that enables agents 106 to use pre-generated templates to send text messages to leads 104. Agents 106 can modify text-message templates to personalize said text messages. Messaging application 108 can display text message threads between an agent(s) and one or more leads 104. Messaging application 108 can send push notifications to agent 106 when a lead has responded to an agent's text message. Messaging application 108 can communicate agent and/or lead messages to administrative entity 110 for analytics. Messaging application 108 can notify administrative agency 110 when agent 106 has failed to timely perform some action (e.g. send a template-text messages to a lead, timely respond to a lead, utilize a specified template in a text message, etc.). Example messaging application 108 user interfaces are provided infro in FIGS. 5-8.

More generally, agents can be various workers, volunteers, or otherwise affiliate persons that directly send text messages to an assigned set of leads. In this way, the agents can personalize text messages, responses, build personalized conversations and/or strengthen relationships with the leads. A lead can be a person or other entity that is interested in and/or affiliated with a service, function, activity, product, etc. of the organization. Agents can interact with their respective set of leads via text messages provided by administrative entity 110. For example, text-message templates can be downloaded from administrative entity 110 to messaging application 108. Messaging application 108 can automatically fill in a template (e.g. based on the agent name, lead name, other known information about the lead, etc.). In the text messages to the leads. For example, other known information about the lead can include a specific donation amount, a target donation amount, a specific address for the lead's polling location that is automatically filled in for the lead, etc. Messaging application 108 can automatically queue the text messages for review by agent 106. Agent 106 can then peruse the text messages and modify the text messages in order to personalize the experience for the respective receiving lead. For example, an agent may personally know a lead. The agent can append queries and/or other personal information to the text message template. In this way, the lead receives a personalized text message from the organization represented by administrative entity 110 and not a depersonalized ‘spam’ style message.

Messaging application 108 can also be used to send reminder messages to leads that indicated event attendance. Messaging application 108 can automatically create a workflow for an agent to send the reminder message. The lead can indicate that she will be attending a political rally (e.g. by replying ‘yes’ or ‘no’ to the agent's text message, etc.). The lead's response can be used to generate and timely send a reminder text message (e.g. a day before the political rally, etc.). The reminders can be placed in the agent's message queue for review and modification/personalization prior to being sent. Messaging application 108 can automatically generate and display a ‘to do’ list to an agent. The ‘to do’ list can be populated with tasks based on incoming tasks from administrative entity 110, lead response content, etc. In some embodiments, an entity can set goals around development a warmth of relationship between it, its agents as its proxies, and the leads. Messaging application 108 can leverage personal details about leads to develop the warmth of relationship (e.g. text messages that wish leads a happy birthday, remind agents to inquire about health of a lead if known lead was ill, etc.). Messaging application 108 can also remind agents to follow up with leads at specified periodic intervals. Messaging application 108 can record and communicate agent metrics to administrative entity 110. Accordingly, the various works flows of messaging application 108 go to the agent who then performs various steps and then causes the personalized text message (e.g. using templates, etc.) to the lead. The lead receives a text message from the lead. From the lead's perspective, the text messages are personalized and not templated text messages. The lead's responses are then communicated to the agent for analysis by the agent and/or messaging application 108.

Messaging application 108 can include an artificial intelligence (AI) functionality. The AI functionality can analyze the behavior of various members of system 100 (e.g. using machine learning algorithms, etc.) and implement/suggest various optimizations. For example, the behavior of these agents can be quantified. The AI functionality can analyze the behavior of the agents with the highest rates of response and/or actions from leads. Successful behavior patterns can be parsed and identified. The behavioral patterns can be communicated to other agents so that it can be incorporated into their behavior patterns. This can be also be implemented for unsuccessful agent behavior patterns as well. Furthermore, this process of analysis and optimization can be repeated for each message content as well.

Administrative entity 110 can set various parameters that control the attributes of text messages sent by agents 106. For example, administrative entity 110 can set windows for which specified text messages can be sent. Administrative entity 110 can specify what parts of the text message can or cannot be modified by agents 106. Administrative entity 110 can specify time periods for responding to lead queries and/or other responses. Messaging application 108 can enforce said parameters and/or report to administrative entity 110 when a parameter is not met by an agent. Administrative entity 110 can send reminders/alerts to agents 106 to perform certain tasks (e.g. when agent 106 has not timely sent a text message template to a lead, etc.). Administrative entity 110 can reassign a set of leads to another agent. Administrative entity 110 can be provided a dashboard whereby an administrator can implement the various manual tasks of administrative entity 110.

An agent can be assigned a specified set of leads to send messages to and/other otherwise engage. The engagement can be based upon a specified organization goal provide by the administrative entity computing system 110 (hereafter ‘administrative entity’). For example, administrative entity 110 can be an organization or a business.

Administrative entity 110 can manage agent assignments in various ways. Example agent-management methods are provided infra in the description of processes 1300-800. Administrative entity 110 match agents based on various factors such as, inter alia: demographic matches (e.g. in same age range, similar educational background, represented by same politician, in same political precinct, etc.), location, past/historical relationships, past agent success in other campaigns, etc. For example, an important lead can be matched with a local agent with a good record of agent responsiveness. In some cases, leads can be matched only with agents that know the lead. In some campaigns, various agent-lead matching settings can be selected. For example, a political campaign may simply with any available agent to contact a lead as the main goal of the campaign may be to simply contact leads. In another example, a fundraising campaign may only have high-trained agents with historical relationships with a wealthy lead contact the lead. In another example, the campaign can begin with restricting types of agents that can contact certain leads, but then remove the restriction late in the campaign to ensure that all the leads are contacted. These functionalities/options can be managed by administrative entity 110.

In one example, administrative entity 110 can be a political campaign and the organizational goal can be to invite the specified group of leads to a campaign event. Agent 106 can be a local campaign volunteer/organizer. Leads 104 can be potential volunteers, event attendees, etc. The political campaign can compose templates and communicate said templates and lead-contact Information to the messaging applications 108 of the local organizers. The local organizers can be assigned a set of potential political rally attendees or other supporters of the candidate. The local organizers can then modify the template to send text messages to the set of potential political rally attendees. In this way, the political campaign can communicate with one or more sets of potential political rally attendees via local organizers with a common message that can be personalized.

In another example, administrative entity 110 can be a university alumni association. Agent 106 can be an alumni organizer. The leads can be other alumni of the university (e.g. a specified portion of a graduating class, a group of alumni with a specified degree, a group of alumni living in a specified geographic region, etc.). The organizational goal can be a university alumni function can the organizational goal can be to request attendance of the lead, another university alumni, at said alumni function.

In another example, administrative entity 110 can be a corporation that sells goods and/or services. Agent 106 can be a sales agent. The leads can be existing customers and/or potential customers. For example, salespeople can utilize messaging service 108 to sell a product. The corporation can create various template messages for its various products. These templates can include product information and/or hyperlinks to a web interface where the product can be purchased. Online payment systems can also be provided and managed by administrative entity 110. Salespeople can also utilize messaging service 108 to implement surveys about the product and/or service. For example, a survey message template can be provided by the corporation. The salesperson can then communicate this to the customer. The survey can include various questions regarding sales and/or product performance (e.g. “how can we improve our service?”, etc.), customer satisfaction, etc. Customer responses can be communicated to agent 106 and/or the corporation. Customer responses can be aggregated and statistical analysis of the aggregated surveys can be implemented.

Administrative entity 110 can provide temporary assignments of agents to leads (e.g. when another agent goes on vacation). Administrative entity 110 can assign agents to a lead based on various factors, inter alia: most responsive available agent, etc. Administrative entity 110 can also leverage an AI functionality to optimize the assignment of agents to lead based on the strength of relationship. Administrative entity 110 can maintain a database of user profiles that include social network data, demographic details, etc. This database can be used in optimizing agent/lead matching. It is noted that administrative entity 110 can maintain a database of leads and information about leads. The lead database can include various information such as data about when each lead is likely to be responsive, whether the lead prefers a short conversation in real-time or a more asynchronous conversation, whether the lead responds better to short or detailed messages, whether the lead has expressed interest in similar campaigns and messaging, blackout time in which not to contact the lead, etc. Administrative entity 110 can periodically perform historical analysis of past campaigns to determine various important lead information to include the lead database.

Third-party servers 112 can provide various services such as, inter alia: search engine services, interface with various messaging networks/services, geo-mapping/location services, encryption/security services, email services, e-payment services, language-translation services, etc. Third-party servers 112 can implement various artificial-intelligence related functionalities, including, inter alia: machine learning, optimization, natural language processes, natural language generation, etc. For example, third-party servers 112 can extract meanings and intents from incoming responses from leads. This material can then be used to generate meaningful templates for replies to said lead responses. Third-party servers 112 can implement analytics of agent behaviors and identify successful agent behaviors. Successful agent behaviors can be determined based on various metrics such as: lead participation rates, lead response rates, agent timeliness, etc. Agents can be ranked based on various metrics. In this way, various pedagogic instructions can be provided to various other agents to improve their actions with system 100. Additionally, higher performing agents can be rewarded and/or sent larger sets of leads.

Messaging services 114 can provide access to various messaging networks such as, inter alia: short messaging service (SMS) networks, multimedia messaging service (MMS) networks, proprietary messaging networks, instant-messaging service networks, email systems, etc. In one example, messaging services 114 can provide a proprietary messaging protocol that maintains a connection between messaging services 114 servers and messaging application 108. Every connection has its own code, which acts as an identifier for the route that can be used to send a message to a specific agent device. The connection can be encrypted (e.g. with TLS using a client-side certificate, that is requested by the device on the activation of messaging protocol. This is provided by way of example and not of limitation. It is noted that messaging application 108 can also be installed into lead 104 computing devices.

It is noted that messaging application 108 can be implemented as a web interface. For example, a web server in administrative entity 110 can provide a set of web pages to a web browser in the agent's mobile device 106. Administrative entity 110 can then implement the functionalities of messaging applications 108 per the instructions uploaded from the agent via his/her input into the web pages.

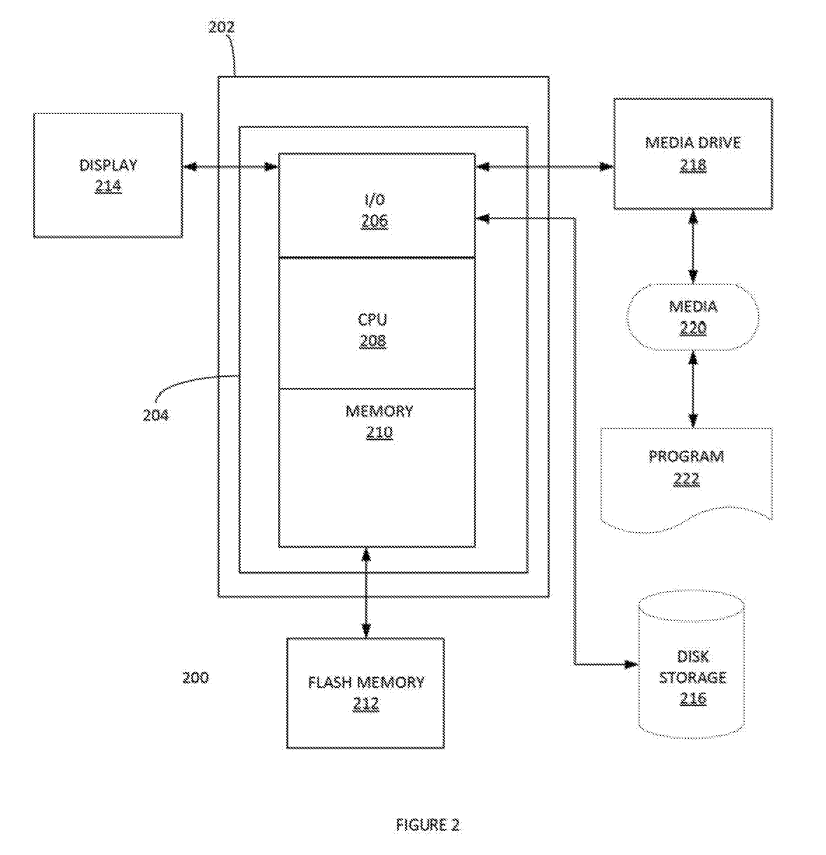

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

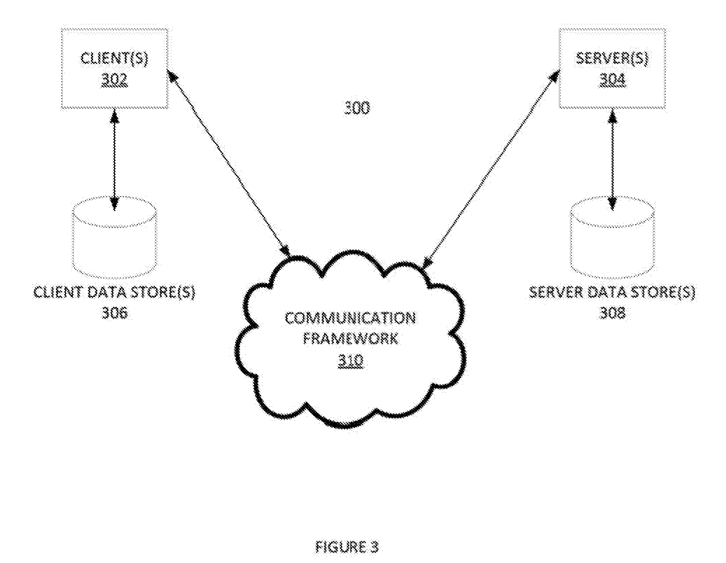

FIG. 3 is a block diagram of a sample computing environment 300 that can be utilized to implement various embodiments. The system 300 further Illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Exemplary Methods

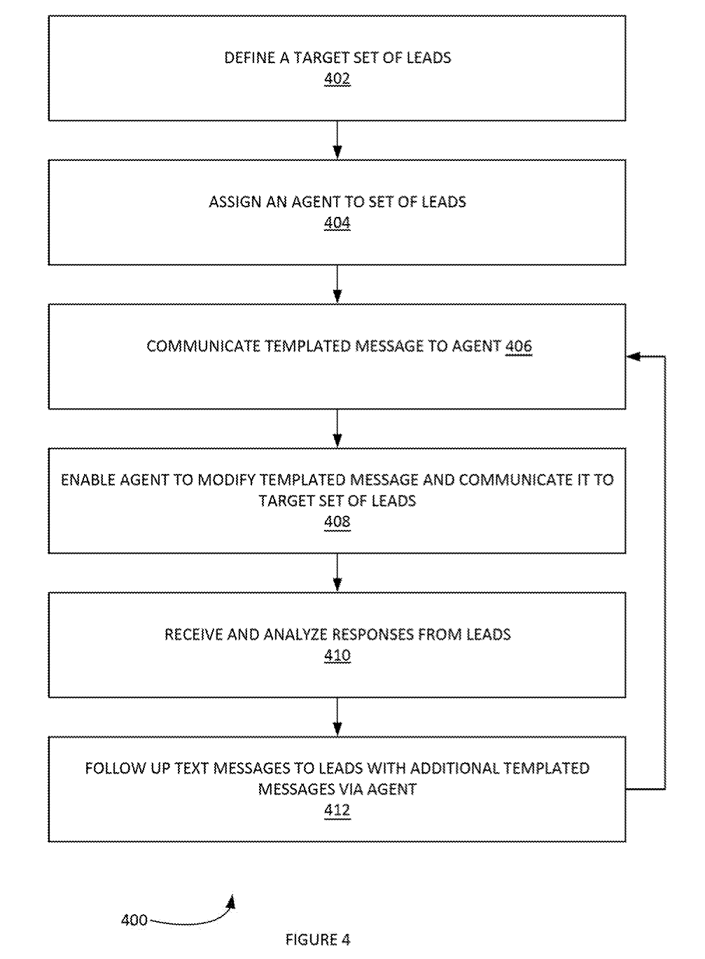

FIG. 4 illustrates an example process 400 for managing engagement with a set of contacts (e.g. leads, invitees, etc.) via templated messages from assigned agents, according to some embodiments. In step 402, process 400 can define a target set of leads. A lead can be a volunteer, alumni group member, employee, etc. An entity can utilize process 400 to communicate text messages to a set of leads via an agent. Accordingly, in step 404, process 400 can assign an agent to set of leads. The agent can be assign the set of leads based on various parameters such as, inter alia: the location of the agent and the leads, historical relationships between the agent and the leads, random assignments, etc.

In step 406, process 400 can communicate the templated message to the agent. For example, process 400 can utilize an application in the agent's computing device. Process 400 can push the templated message to the agent's application. In step 408, process 400 can enable agent to modify templated message and communicate it to target set of leads. The application can provide a UI to the agent. The agent can then quickly input simple commands (e.g. touch screen taps, swipes, etc.) to modify text messages on a per lead basis. In this way, template-text messages originally generated by a central administrator in the source entity can be personalized for each lead. For example, the agent can enhance the templated message with a brief phrase with personal information from the agent-lead relationship (e.g. “I hope your job is going well!”, “good seeing you last Saturday”, etc.).

In step 410, process 400 can receive and analyze responses from leads. For example, a modified-templated message can include graphical user elements whereby a lead can indicate a response choice (e.g. Indicate she is coming to a meeting, will be at an election rally, will complete a specified task, etc.). Process 400 can receive this information and implement various analytics. For example, process 400 can track a number of leads who will attend an event, etc. In step 412, process 400 can then send follow up text messages to leads with additional template-text messages via agent. Step 412 can utilize agents as an interface for interacting with leads in a similar manner to steps 406 to 410. The agent's and/or lead's application can present a thread of historical text messages between the agent and lead. In this way, each can quickly review the content of the thread and understand the context of their text-message conversation. In one example, a first text message to a lead from an agent can automatically include an introduction section. This introduction section can be automatically removed when prior texts are detected in the communication thread between the agent and the lead.

Agent Management Methods and Systems

FIG. 5 illustrates an example process 500 for managing agent interactions with a set of leads, according to some embodiments. process 500 can utilize agent-templated messages in a campaign. in step 502, process 500 can define a target set of leads for a campaign. In step 504, process 500 can assign each agent to a subset of leads. In step 506, process 300 can monitor each agent's metrics with respect to each subset of leads. In step 508, process 500 can determine if the agent is meeting lead-contact metrics within specified time period. If ‘no’, then process 500 can reassign a portion (or all) of the respective agent's leads to another agent. Process 500 can then return to an earlier step such as step 506. If ‘yes’, then process 500 can maintain the agent's status quo. Process 500 can then return to an earlier step such as step 506. Once all the leads have been contacted, process 500 can terminate. In some examples, process 500 can terminate based on another metric such as, Inter alia: a specified amount of RSVP's is received, a specified amount of money is raised, a specified percentage of leads are contacted, a time limited is met, etc. Various steps and/or decisions made by process 500 can be algorithmically determined using machine learning, ranking and/or various optimization techniques (e.g. see supro).

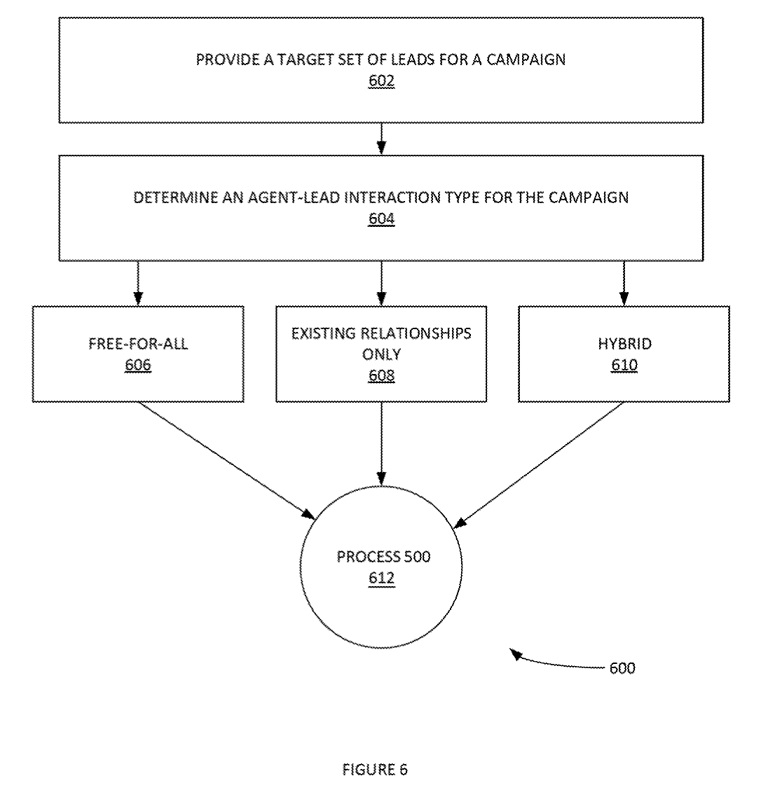

FIG. 6 illustrates an example process 600 of selecting agents to be matched with a set of leads, according to some embodiments. In step 602, process 600 can provide a target set of leads for a campaign. In step 604, process 604 can determine an agent-lead interaction type for the campaign. Example agent-lead interaction types can include, for example: free-for-all relationship 606; an existing relationship only 608; a hybrid relationship; etc. A free-for-all relationship 606 can be a random assignment of agents to leads. In some examples, minimal agent/lead attributes can be used for some matching. The goal can be to ensure that all leads are matched with at least one agent. For exist relationship only 608, only agents with a historical relationship are matched with leads. In a hybrid relationship, some higher value leads can be matched with agents with historical relationships. Other leads can be matched randomly (and/or other factors such as: agent capacity, similar attributes, etc.). In a Process 600 can then proceed to another process that utilizes agent-curated text messages (e.g. templated messages, etc.). Process 500 is an example process that utilizes agent-curated text messages. Various steps and/or decisions made by process 600 can be algorithmically determined using machine learning, ranking and/or various optimization techniques (e.g. see supra).

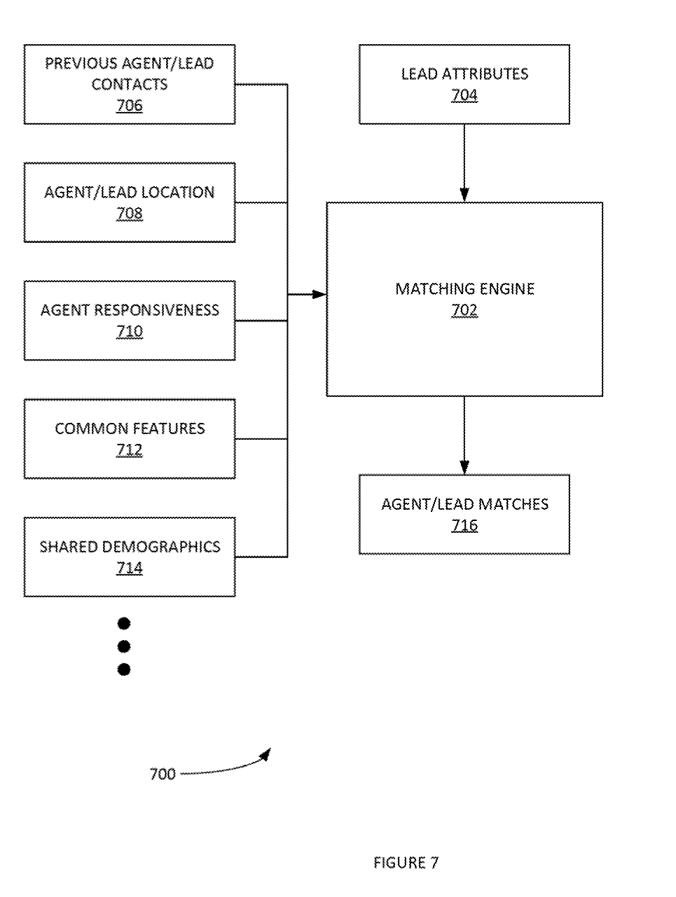

FIG. 7 illustrates another example process 700 of selecting agents to be matched with a set of leads, according to some embodiments. A matching engine 702 can obtain a set of attributes from a lead(s) 704. The matching engine 702 can receive a set of agent and/or agent/lead attributes. Examples of these attributes include, inter alia: previous agent/lead contacts 706, agent/lead location 708, agent responsiveness 710, common features 712, shared demographics 714, etc. Matching engine 702 can weight agent attributes and/or lead attributes and apply a matching algorithm to determine matches between agents and leads. Matching engine 702 can utilize machine learning and/or various optimization algorithms to determine an optimized weighting scheme. Historical databases of agent/lead matches and campaign successes can be utilized in this process. Matching engine 702 can generate a list of agent/lead matches 706. Matching engine 702 can periodically update a set of agent/lead matches 706 during a campaign. For example, process 700 can be utilized by process 800.

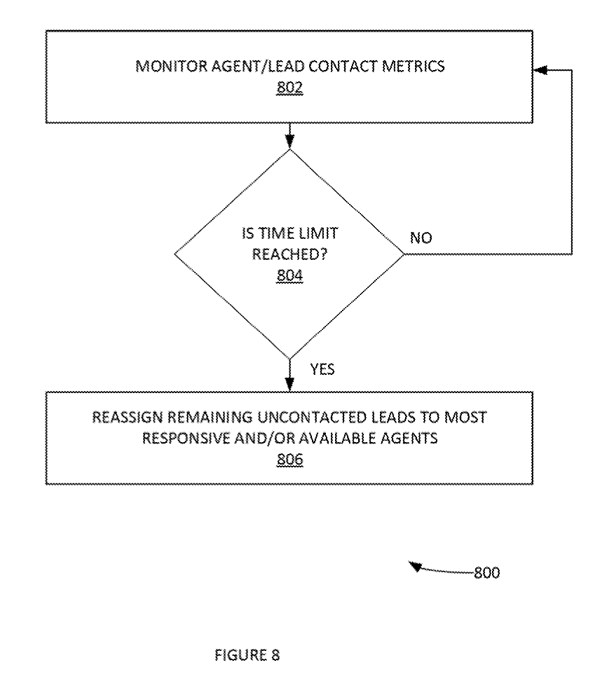

FIG. 8 illustrates an example process 800 for updating which agents are assigned to a subset of clients. In step 802, process 800 can monitor agent/lead contact metrics. For example, a list of uncontacted leads can be maintained. A list of each agent's uncontacted leads can be maintained as well. other agent actions with respect to agent-templated messages can be determined. In step 804, it can be determined if a time limit is reached. The time limit can be a time before the termination of the curated text messaging campaign (e.g. one week before termination, one day before termination, etc.). If ‘no’ then process 800 can return to step 802. If ‘yes’, then process 800 can proceed to step 806. In step 806, process 800 can reassign remaining uncontacted leads to most responsive and/or available agents. In this way, all (or most) of the leads can be contacted and/or interacted with in a specified manner.

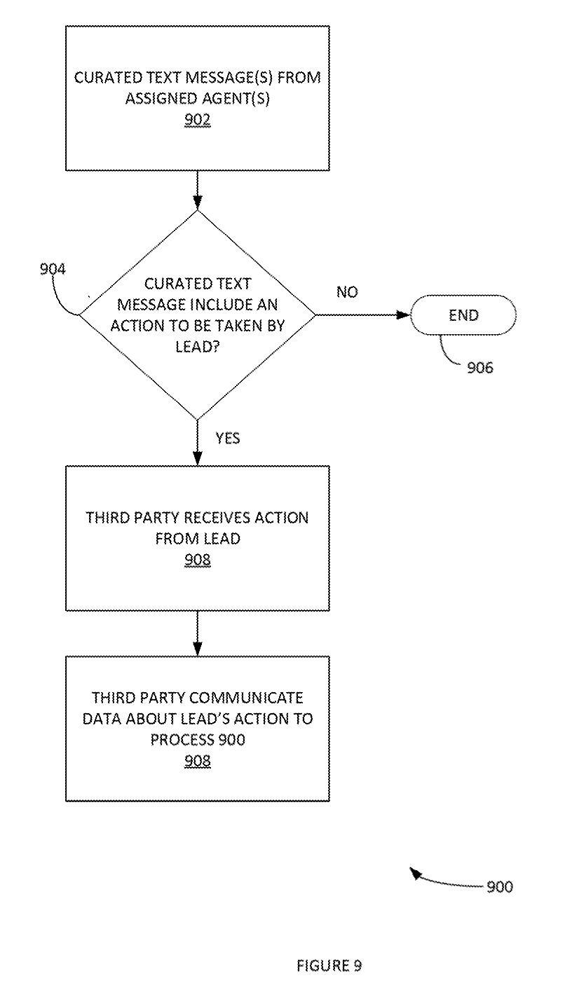

FIG. 9 illustrates an example process 900 for tracking lead engagement with a curated text message, according to some embodiments. Process 900 can implement conversion tracking. For data from third parties (e.g. online payment platforms, online subscription service platforms, etc.). The third party (e.g. third-party servers 112, etc.) can then sends the organization administrator information about these conversion events when a lead/supporter makes a purchase or donation. Process 900 can use this data to prompt for additional agent flows as part of a goal. For example, the organization administrator can have set additional steps for a fundraising goal (e.g. thanking, reminding, etc.). Accordingly, templated messages can that thank all leads that make a purchase or donation. A templated reminder message can be communicated to leads that have not yet made a purchase or donation. These conversion events can be loaded via an upload of a file (e.g. a CSV file, etc.) and/or automatically pushed to the organization's server(s) via an API and/or pulled by the organization's server(s) from a third-party API.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for managing agent relationships with a set of contacts via templated messages comprising:
providing a goal of an entity organization;
providing a set of leads;
identifying an agent, wherein the agent has a pre-existing relationship with the set of leads;
assigning the agent to the set of leads;
generating a templated message, wherein the templated message is addressed to the set of leads and comprises a set of templated text related to the goal of the entity organization, and wherein the set of templated text is written by an administrator of the entity organization;
communicating the templated message to the agent, wherein the agent is enabled to modify the templated message, and wherein the agent implements with each individual lead of the set of leads:
identifies a set of relationships between the agent and the individual lead;
based on the set of relationships, modifies the templated message; and
communicates, from a templated-text message application implemented in a computing device of the agent, via an electronic text-messaging network an individualized templated message to another computing device of the individual lead.

2. The computerized method of claim 1 further comprising:
receiving a text response from a lead with the templated-text message application implemented in a mobile device of the agent.

3. The computerized method of claim 1, wherein a lead comprises a voter, a volunteer, an alumni group member or a donor.

4. The computerized method of claim 1, wherein a template comprises a port of a text message that is included in all text messages to the set of leads.

5. The computerized method of claim 1, wherein the electronic text-messaging network comprises an instant messaging network, a short-messaging service (SMS) network or an (MMS) multi-media network.

6. The computerized method of claim 1, wherein the pre-existing relationship with the set of leads comprises a location of the agent with respect to an average location of set of leads and an existence of a historical relationship between the agent and the set of leads.

7. A computer system useful for useful for managing agent relationships with a set of contacts via templated messages comprising:
a processor;
a memory containing instructions when executed on the processor, causes the processor to perform operations that:
provide a set of leads;
identify an agent, wherein the agent has a pre-existing relationship with the set of leads;
assign the agent to the set of leads;
generate a templated message, wherein the templated message is addressed to the set of leads and comprises a set of templated text related to a goal of the entity organization;
communicate the templated message to the agent, wherein the agent is enabled to modify the templated message, and wherein the agent implements with each individual lead of the set of leads:
identifies a set of relationships between the agent and the individual lead;
based on the set of relationships, modifies the templated message; and
communicates, from a templated-text message application implemented in a computing device of the agent, via an electronic text-messaging network an individualized templated message to another computing device of the individual lead.

8. The computer system of claim 9, wherein the memory containing instructions when executed on the processor, causes the processor to perform operations that further comprising:
receive a text response from a lead with the templated-text message application implemented in a mobile device of the agent.

9. The computer system of claim 9, wherein a lead comprises a voter, a volunteer, an alumni group member or a donor.

10. The computerized method of claim 10, wherein a template comprises a port of a text message that is included in all text messages to the set of leads.

11. The computerized method of claim 10, wherein the electronic text-messaging network comprises an instant messaging network, a short-messaging service (SMS) network or an (MMS) multi-media network.

12. The computerized method of claim 11, wherein the pre-existing relationship with the set of leads comprises a location of the agent with respect to an average location of set of leads and an existence of a historical relationship between the agent and the set of leads.

13. The computer system of claim 12, wherein the set of templated text is written by an administrator of the entity organization.

14. The computer system of claim 13, wherein the memory containing instructions when executed on the processor, causes the processor to perform operations that further comprising:
based on an analysis of the text response from the lead by the administrator:
generate a follow-up templated message, wherein the follow-up templated message is addressed to a subset of the set of leads and comprises a set of templated text related to a goal of the entity organization and a content of the text response;
communicate the follow-up templated message to the agent, wherein the agent is enabled to modify the follow-up templated message, and wherein the agent implements with each individual lead of the subset of the set of leads:
based on the set of relationships and the content of the text response, modifies the follow-up templated message; and
communicates, from the templated-text message application implemented in the computing device of the agent, via an electronic text-messaging network, an individualized follow-up templated message to the other computing device of each individual lead in the subset of the set of leads.
